(19) United States
(12) Patent Application Publication
(10) Pub. No.: US 2005/0203193 A1
(43) Pub. Date: Sep. 15, 2005

(54) Demulsifiers

(75) Inventors: Dirk Leinweber, Burghausen (DE); Michael Feustel, Koengernheim (DE); Heidi Grundner, Garching/Alz (DE); Hildegard Freundl, Burgkirchen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT GmbH, Frankfurt Am Main (DE)

(21) Appl. No.: 10/515,897

(22) PCT Filed: May 16, 2003
(86) PCT No.: PCT/EP03/05155

§ 371 Date: Nov. 23, 2004

(30) Foreign Application Priority Data
May 31, 2002 (DE) 102 24 275.5

(51) Int. Cl. B01D 17/05

(52) U.S. Cl. 516/189

(57) ABSTRACT

The invention relates to polymers that can be obtained by: A) reacting an epoxidized ester, which is selected from one or more unsaturated fatty acids having 8 to 26 C atoms and a polyol having 2 to 6 OH groups, with a monoamine, diamine or polyamine; B) alkoxylating the polyamine obtained hereby with a C₂ to C₄ alkylene oxide in molar excess so that the average degree of alkoxylation per OH group ranges from 1 to 100. The polymers have a numerical average molecular weight ranging from 500 to 100,000 g/mol. The invention also relates to the use of these polymers in quantities ranging from 0.0001 to 5% by weight with regard to the oil as demulsifiers for oil-in-water emulsions.

The present invention relates to the use of polymers, preparable by reaction of epoxidized fatty acid esters with amines and subsequent alkoxylation, for breaking water/oil emulsions, in particular in the production of crude oil.

During its recovery, crude oil is produced as an emulsion with water. Before the crude oil is processed further, these crude oil emulsions have to be broken into the oil and water constituents. For this purpose, use is generally made of petroleum breakers. Petroleum breakers are interface-active compounds which are able to effect the required separation of the emulsion constituents within a short time.

The petroleum breakers used are, inter alia, alkylphenol aldehyde resins, which are disclosed, for example, in U.S. Pat. No. 4,032,514. These resins are obtainable from the condensation of a p-alkylphenol with an aldehyde, in most cases formaldehyde. The resins are often used in alkoxylated form, as is disclosed, for example, in DE-A-24 45 873. For this, the free phenolic OH groups are reacted with an alkylene oxide.

Alkylphenol-free demulsifiers are described in WO-A-99/07808. Here, epoxidized fatty acid esters are opened with alcohols or carboxylic acids, and the resulting OH function is reacted with alkylene oxides. The compounds prepared from this have good properties as demulsifiers.

The varying properties (such as, for example, asphaltene and paraffin content) and water fractions of different crude oils make it imperative to further develop the existing petroleum demulsifiers. In particular, a low dosing rate of the demulsifier to be used besides the higher effectiveness which is to be strived for is at the front from an economic and ecological point of view.

It was therefore the object to develop novel petroleum breakers which are superior in their effect to the products already known, and can be used in an even lower concentration.

Surprisingly, it has been found that products which are based on ring-opening products of epoxidized fatty acid esters with amines, diamines or polyamines, after subsequent alkoxylation, have an excellent breaking effect even at a very low concentration compared with known emulsion breakers.

The invention provides polymers obtainable by

A) reaction of an epoxidized ester of one or more unsaturated fatty acids having 8 to 26 carbon atoms and a polyol having 2 to 6 OH groups with a monoamine, diamine or polyamine

B) alkoxylation of the resulting polyamine with a C₂- to C₄-alkylene oxide in molar excess, such that the average degree of alkoxylation per OH group is between 1 and 100,

where the polymers have number-average molecular weights of from 500 to 100 000 g/mol.

The invention further provides the use of the polymers according to the invention in amounts of from 0.0001 to 5% by weight, based on the oil, as breakers for oil/water emulsions.

The invention further provides a method of breaking oil/water emulsions by adding the polymers according to the invention to the emulsion in amounts of from 0.0001 to 5% by weight.

The first step (stage A) for the preparation of the polymers according to the invention consists in reacting an epoxidized fatty acid polyol ester with a monoamine, diamine or polyamine.

Epoxidized fatty acid polyol esters correspond generally to the formula 1 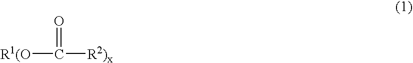
in which

R¹ is a hydrocarbon group having 2 to 6 carbon atoms which has x valences overall,

R² is a polymethylene group having 1 1 to 25 carbon atoms which carries at least one epoxide group, and

x is a number from 2 to 6.

The esters of the formula 1 can be synthesized by esterifying a polyol of the formula R¹(OH)ₓ with one or more carboxylic acids of the formula R²COOH. R¹, x and R² have the meaning given above.

The esters are preferably complete esters, although they can also have free OH groups. They are preferably based on naturally occurring glycerides, such as, for example, soybean oil, olive oil, sunflower oil or linseed oil.

x is preferably 2 or 3.

R¹ is preferably derived from ethylene glycol, propylene glycol, diethylene glycol, pentaerythritol, trimethylolpropane or glycerol. Particular preference is given to ethylene glycol and glycerol.

R² is preferably a polymethylene group having 9 to 21 carbon atoms, and is thus preferably derived from a C₁₀- to C₂₂-carboxylic acid. R² can carry 1, 2 or 3 epoxide groups.

The molecular weight of the polymers according to the invention is preferably at least 1000, for example 2000 g/mol, in particular from 1000 to 50 000 g/mol.

Formula 2 illustrates the ester structure of one example derived from glycerol

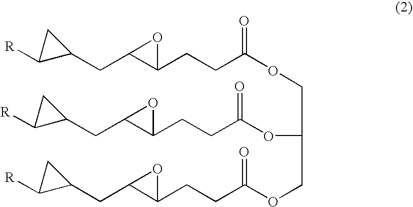

R is a hydrocarbon group which completes the fatty acid radical.

The epoxide ring opening may be carried out uncatalyzed (high nucleophilicity of the amines), with an acid catalyst or with a base catalyst. Base catalysis by means of sodium methoxide or potassium tert-butoxide has proven to be particularly preferred since it leads to more uniform products in significantly shorter reaction times.

Suitable amines preferably correspond to the formulae 3 to 5
R³NH (3)
R³R⁴NH (4)

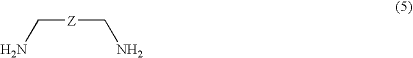

R³ and R⁴, independently of one another, are C₁- to C₄₀-alkyl, C₂- to C₄₀-alkenyl, C₆- to C₁₈-aryl or C₇- to C₃₀-alkylaryl, in particular C₆- to C₂₂, especially C₁₀- to C₁₈-alkyl or alkenyl, which may be straight-chain or branched.

Z is —(CH₂)ₙ— where n=0 to 10 or —(CH₂NHCH₂)ₘ— where m=1 to 20.

Formulae 7 and 8 show particularly preferred compounds based on soybean oil epoxide. Soybean oil epoxide is the epoxidized form of the natural substance soybean oil, which is the triglyceride of a polyunsaturated C₁₆-C₁₈-fatty acid. An idealized chemical structure is given in formula 6. On average, soybean oil epoxide has 6 to 7 epoxide groups.

If R³ and R⁴ are an alkylaryl radical, the alkylaryl is preferably a radical bonded via the aromatic ring, the aromatic ring of which preferably comprises 6 carbon atoms, and which carries an alkyl radical with a chain length of from preferably 1 to 18, particularly preferably 4 to 16, in particular 6 to 12, carbon atoms in the o, m or p position relative to the abovementioned bond.

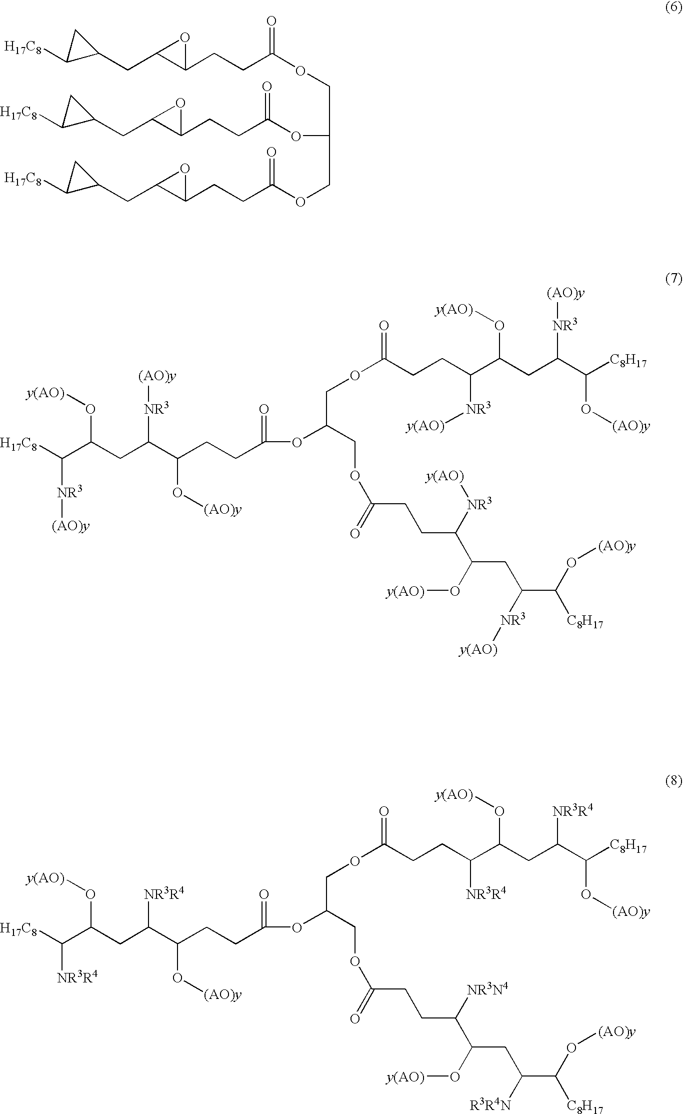

(AO)_{y}O is an alkoxylated OH radical, (AO)_{y}N is an alkoxylated NH radical in which AO is the alkylene oxide unit, and y gives the degree of alkoxylation. y is preferably between 2 and 80.

For use as petroleum breakers, the polymers are added to the water/oil emulsions, which preferably takes place in solution. Preferred solvents for the polymers are paraffinic or aromatic solvents. The polymers are used in amounts of from 0.0001 to 5% by weight, preferably 0.0005 to 2% by weight, in particular 0.0008 to 1% by weight and specifically 0.001 to 0.1% by weight, of polymer based on the oil content of the emulsion to be broken.

As is known in the prior art, the alkoxylation takes place by reacting the ring-opening products with an alkylene oxide (preferably: ethylene oxide, propylene oxide or butylene oxide) under an increased pressure of generally from 1.1 to 20 bar at temperatures of from 50 to 200° C.

### EXAMPLES

1. Reaction of Soybean Oil Epoxide With Coconut Fatty Amine (Uncatalyzed)

194 g (1 mol) of coconut fatty amine were heated to 160° C. under a nitrogen atmosphere. 235 g of soybean oil epoxide (1 eq. of epoxide/mol of amine) were added dropwise with stirring over the course of one hour. To conclude the reaction, the mixture was left to after-react for 10 h at 150° C. This gave a clear-yellow slightly viscous product which was analyzed by means of NMR and GPC.

2. Reaction of Soybean Oil Epoxide With Coconut Fatty Amine (NaOMe-Catalyzed)

194 g (1 mol) of coconut fatty amine and 1.8 g of sodium methoxide (1 mol %, 30% strength in methanol) were heated to 160° C. under a nitrogen atmosphere. 235 g of soybean oil epoxide (1 eq. of epoxide/mol of amine) were added dropwise with stirring over the course of one hour. To conclude the reaction, the mixture was left to after-react for 4 h at 150° C. This gave a clear yellow slightly viscous product which was analyzed by means of NMR and GPC.

3. Reaction of Soybean Oil Epoxide With Dicoconut Fatty Amine (NaOMe-Catalyzed)

405 g (1 mol) of dicoconut fatty amine and 4.5 g of sodium methoxide (2.5 mol %, 30% strength in methanol) were heated to 170° C. under a nitrogen atmosphere. 235 g of soybean oil epoxide (1 eq. of epoxide/mol of amine) were added dropwise with stirring over the course of one hour. To conclude the reaction, the mixture was left to after-react for 8 h at 170° C. This gave a clear yellow slightly viscous product which was analyzed by means of NMR and GPC.

4. Reaction of Soybean Oil Epoxide With Triethylenetetramine (NaOMe-Catalyzed)

157 g (1 mol) of triethylenetetramine and 1.8 g of sodium methoxide (1 mol %, 30% strength in methanol) were heated to 80° C. under a nitrogen atmosphere. 235 g of soybean oil epoxide (1 eq. of epoxide/mol of amine) were added dropwise with stirring over the course of one hour. To conclude the reaction, the mixture was left to after-react for 7 h at 80° C. This gave a clear yellow product which was solid at room temperature, which was analyzed by means of NMR and GPC.

5. Reaction of Soybean Oil Epoxide with Tetraethylenepentamine (NAOMe-Catalyzed)

222 g (1 mol) of tetraethylenepentamine and 1.8 g of sodium methoxide (1 mol %, 30% strength in methanol) were heated to 80° C. under a nitrogen atmosphere. 235 g of soybean oil epoxide (1 eq. of epoxide/mol of amine) were added dropwise with stirring over the course of one hour. To complete the reaction, the mixture was left to after-react for 7 h at 80° C. This gave a clear yellow product which was solid at room temperature, which was analyzed by means of NMR and GPC.

Alkoxylation of the Amine-Opened Epoxidized Carboxylic Esters

Ethylene Oxide

The above-described ring-opening products were introduced into a 1 l glass autoclave and the pressure in the autoclave was adjusted to about 0.2 bar above atmospheric pressure using nitrogen. It was heated slowly to 140° C. and, after this temperature had been reached, the pressure was again adjusted to 0.2 bar above atmospheric pressure. Subsequently, at 140° C., the desired amount of EO was metered in, during which the pressure should not exceed 4.5 bar. When the addition of EO was complete, the mixture was left to after-react for a further 30 minutes at 140° C.

Propylene Oxide

The above-described ring-opening products were introduced into a 1 l glass autoclave and the pressure in the autoclave was adjusted to about 0.2 bar above atmospheric pressure using nitrogen. It was heated slowly to 130° C. and, after this temperature had been reached, the pressure was again adjusted to 0.2 bar above atmospheric pressure. Subsequently, at 130° C., the desired amount of EO was metered in, during which the pressure should not exceed 4.0 bar. When the addition of EO was complete, the mixture was left to after-react for a further 30 minutes at 130° C.

Determination of the Breaking Effectiveness of Petroleum Demulsifiers

To determine the effectiveness of a demulsifier, the water separation from a crude oil emulsion per time, and also the dewatering and desalting of the oil were determined. For this, the demulsifying glasses (tapered, graduated glass bottles with screw lids) were charged in each case with 100 ml of the crude oil emulsion, in each case a defined amount of the demulsifier was metered in just below the surface of the oil emulsion using a micropipette, and the breaker was mixed into the emulsion by intensive shaking. The demulsifying glasses were then placed in a conditioning bath (30° C. and 50° C.) and water separation was monitored.

During demulsification and after it had finished, samples were taken from the oil from the upper section of the demulsifying glass (so-called top oil), and the water content was determined in accordance with Karl Fischer and the salt content was determined conductometrically. In this way, it was possible to assess the novel breakers according to water separation and also dewatering and desalting of the oil.

Breaking Action of the Demulsifiers Described

Origin of the crude oil emulsion: Holzkirchen sonde 3, Germany

Water content of the emulsion: 46%

Salt content of the emulsion: 5%

Demulsification temperature: 50° C.

Concentration: 20 ppm

| | | | | | | | Water | Salt in |
|---|---|---|---|---|---|---|---|---|
| | | | | | | | in the | the |
| Water separation [ml] | | | | | | | top oil | top oil |
| per time [min] | 5 | 20 | 30 | 60 | 90 | 180 | [%] | (ppm] |
| Alkoxylated product | 2 | 10 | 30 | 41 | 43 | 45 | 0.45 | 28 |
| from Example 1 | | | | | | | | |
| Alkoxylated product | 8 | 16 | 37 | 44 | 46 | 46 | 0.15 | 20 |
| from Example 2 | | | | | | | | |
| Alkoxylated product | 10 | 19 | 38 | 45 | 45 | 46 | 0.11 | 16 |
| from Example 3 | | | | | | | | |
| Alkoxylated product | 9 | 17 | 38 | 46 | 46 | 46 | 0.12 | 15 |
| from Example 4 | | | | | | | | |
| Dissolvan 3245 | 1 | 8 | 27 | 37 | 40 | 41 | 0.97 | 87 |
| (standard) | | | | | | | | |

1. A method for breaking oil/water emulsions, said method comprising adding to the oil/water emulsion a polymer obtained by
A) reaction of an epoxidized ester of one or more unsaturated fatty acids having 8 to 26 carbon atoms and a polyol having 2 to 6 OH groups with a monoamine, diamine or polyamine
B) alkoxylation of the resulting polyamine with a C₂- to C₄-alkylene oxide in molar excess, such that the average degree of alkoxylation per OH group is between 1 and 100,
where the polymer has a number-average molecular weight of from 500 to 100 000 g/mol, in amounts of from 0.0001 to 5% by weight, based on the oil.

2. The method of claim 1, wherein the polyol is selected from the group consisting of ethylene glycol, propylene glycol, diethylene glycol, pentaerythritol, trimethylolpropane, glycerol, and mixtures thereof.

3. The method of claim 1, wherein the epoxidized ester is derived from a naturally occurring glyceride.

4. The method of claim 1, wherein the polymer has a number-average molecular weight of from 1000 to 50 000 g/mol.

5. The method of claim 1, wherein the epoxidized ester is derived from a C₁₀- to C₂₂-carboxylic acid.

6. The method of claim 1, wherein the epoxidized ester is derived from a naturally occurring glyceride selected from the group consisting of soybean oil, olive oil, sunflower oil, linseed oil, and mixtures thereof.
